(19) United States
(12) Patent Application Publication
(10) Pub. No.: US 2009/0158559 A1
(43) Pub. Date: Jun. 25, 2009

(54) QUICK-ACTION CLAMPING COLLAR

(75) Inventors: Gerard Chardon, Lyon (FR); Frederic Veillon, Echalas (FR)

Correspondence Address: CANTOR COLBURN, LLP, 20 Church Street, 22nd Floor, Hartford, CT, 06103, US

(73) Assignee: ALDES AERAULIQUE, Venissieux (FR)

(21) Appl. No.: 12/093,122

(22) PCT Filed: Oct. 31, 2006
(86) PCT No.: PCT/FR06/02437

§ 371 Date: Sep. 11, 2008

(30) Foreign Application Priority Data
Nov. 9, 2005 (FR) 0511409

(51) Int. Cl. F16L 33/035

(52) U.S. Cl. 24/16 PB

(57) ABSTRACT

The collar is embodied in the form of a single annular slotted piece (1) comprising a base body (2) and two ends (3, 4) provided with corresponding opposite toothings (7, 9) which are engageable into each other and each of which is provided with a row of teeth inclined in a direction opposite to the collar closing direction (F). An intermediate part of the base body (2) is corrugated in such a way that a hinge (10) is formed. A plurality of flexible tabs (11), which are inclined towards the hinge (10) and radially inwardly projected, is circumferentially distributed through a surface radially internal with respect to the base body (2). Said invention is suitable for connecting flexible or semi-flexible conduits single or double skinned, in particular for ventilation system air-conveying conduits.

### TECHNICAL FIELD OF THE INVENTION

The present invention relates to a quick-action clamping collar particularly intended for connecting a flexible or semiflexible duct to a fixed point, for example to a ventilation unit.

### BRIEF SUMMARY OF RELATED ART

In particular, it is known practice to produce such a clamping collar in the form of a single basically annular split component that comprises a basic body and two locking ends with corresponding opposing teeth designed to engage with each other. The teeth are inclined in an opposite direction to the closing direction of the collar. The collar ends are disengaged by first moving one of the sets of teeth in a direction perpendicular to its plane, and then extracting it from the other end.

That type of collar, which is usually made of a synthetic material, provides an effective connection with no risk of accidental disengagement of its ends.

A ventilation duct for carrying air usually comprises a helical wire core and a plastic or aluminum “skin”. This skin is sometimes covered with a second skin wrapped around a thin insulating layer. Such ducts are said to be “double skinned”.

Because of their flexibility, such ducts can be deformed and their outside diameter can vary. This can cause the clamping collar to come lose.

### BRIEF SUMMARY OF THE INVENTION

The present invention is intended to avoid this problem by providing a clamping collar of the abovementioned type capable of providing an effective connection to a single or double skinned flexible or semiflexible duct.

For this purpose, the subject of the invention is a clamping collar comprising a single split component, comprising a basic body and two locking ends with corresponding opposing teeth designed to engage with each other, the teeth being inclined in an opposite direction to the closing direction of the collar, and an intermediate part of the basic body being sinuous so as to form a hinge, which collar comprises a plurality of flexible tabs inclined toward said hinge, distributed circumferentially and projecting radially inwardly, on a radially inward surface of the basic body on each side of the hinge.

The idea on which the invention is based is therefore to have the collar adapt to any variations in the diameter of a flexible or semiflexible duct, by using flexible tabs on the inside wall of the basic body of the collar, which tabs flex, when the collar is mounted on the duct, against the outside wall of the duct in such a way as to apply pressure to this wall and clamp the duct effectively.

The flexibility of the hinge facilitates the fitting of the clamping collar around the duct in question, while the direction in which the tabs bend when the collar is tightened is pre-determined by the fact that they are inclined toward the hinge.

Another aspect of the present invention is that the basic body may have on one side of the collar an area that is wider than the locking ends. This arrangement is particularly advantageous when, owing to geometrical constraints, the duct to be connected has to be bent on the other side of the clamping collar. The widening of the basic body is then positioned in such a way as to form at the bend of the duct a projecting surface to support and guide the duct and so increase the radius of curvature of the bend and guide and secure the fastening.

The figures of the appended drawing, given by way of non-restrictive example, will show clearly how the invention can be implemented.

### BRIEF DESCRIPTION OF THE DRAWINGS

FIG. 1 is a perspective view of a collar according to the invention in an unattached position.

FIG. 2 is a top view of the collar shown in FIG. 1.

FIG. 3 is a side view of the same collar.

### DETAILED DESCRIPTION

As can be seen in the drawing, the clamping collar according to the invention consists of a single component 1 of split annular shape, comprising a basic body 2 and two locking ends 3 and 4.

A first end 3 of the collar has a radially outward projection 5 and then, on an upper face, that is to say a radially outward face, teeth 7 inclined in an opposite direction to the closing direction of the collar.

The other end 4 of the collar is directed toward the first end 3 and forms a tab which acts as a lead-in for engaging the end 3.

The end 4 also has a radially outward projection 6 which leads into a curved arm 8 formed approximately parallel to the tab 4.

Teeth 9 are formed on the lower or radially inward face of the arm 8.

The teeth 9 are inclined, like the teeth 7, in such a way that the two sets of teeth 7 and 9 can be engaged progressively with each other simply by manually pushing the two projections 5 and 6 toward each other in a collar closing direction (arrow F).

The teeth 7 and 9 then engage in each other until they reach a position in which the collar is clamped around a duct (not shown).

On the other hand, the slope of these teeth 7 and 9 prevents them from being disengaged by pulling them in the opposite direction.

The ends of the collar are disengaged by first moving one of the sets of teeth in a direction perpendicular to its plane, and then extracting it from the other end.

An intermediate part of the basic body 2, approximately half way between the two ends 3 and 4, is sinuous, forming a hinge 10, the flexibility of which facilitates fitting the clamping collar to the duct and allows the ends 3 and 4 to be brought together and engaged with each other, thus closing the collar.

Flexible tabs 11 projecting radially inwardly are distributed circumferentially on a radially inward surface of the basic body 2. The flexible tabs 11 are positioned on each side of the hinge 10 and are inclined toward the latter. The direction in which the tabs 11 bend when the collar is tightened is thus pre-determined by the fact that they are inclined toward the hinge 10 of the collar.

When the collar is mounted on the duct, the flexible tabs 11 flex against the outside wall of the duct in such a way as to apply pressure and clamp the duct effectively. This arrangement makes it possible to absorb and compensate for variations in the diameter of the duct caused by the latter's flexibility.

Thus, the two ends 3 and 4 of the collar remain engaged with each other in a fixed manner and there is no risk of their coming accidentally free.

Adjustment of the tightness of the collar is also provided automatically, quickly and reliably by the flexible tabs 11.

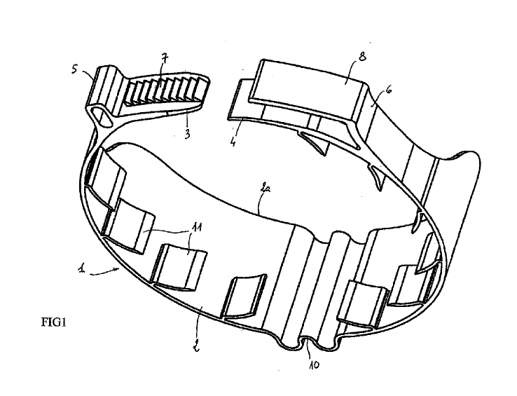

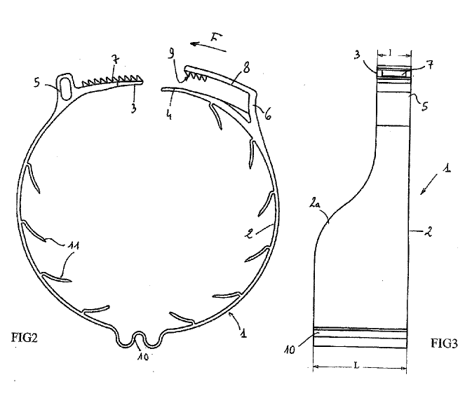

FIGS. 1 and 3 show that, in a complementary aspect of the invention, the basic body 2 has on one side of the collar an area 2a that is wider than the ends 3 and 4. The width L of the basic body 2 is thus substantially greater than the width 1 of the ends 3 and 4 of the collar.

This arrangement is particularly advantageous when, owing to geometrical constraints, the duct to be connected has to be bent on the other side of the clamping collar.

This circumstance may for example occur when connecting a flexible air conveying duct to a ventilation unit in a confined space requiring that the duct be bent at the point where it is attached to the ventilation unit.

The wider area 2a of the basic body 2 is in this case positioned in such a way as to form at the elbow (not shown) of the duct a projecting surface that supports and guides the duct and so increases the radius of curvature of the bend and guides and secures the fastening.

Clearly, the collar according to the invention can be used on various diameters of ducts, whether single-skinned or double-skinned (in other words containing an integrated insulating layer), notably by suitably modifying the length of the annular component 1, the length of the series of teeth 7, and optionally the number of teeth 7 and 9.

It would furthermore not constitute a departure from the scope of the invention to make the system of mutual engagement between the two ends 3 and 4 of the collar in a different form, for example by forming the teeth 9 on the upper face of the end 4 and the teeth 7 on the lower face of the end 3.

1. A quick-action clamping collar including a single split component, comprising a basic body and two locking ends with corresponding opposing teeth designed to engage with each other, the teeth being inclined in an opposite direction to a closing direction of the collar, and an intermediate part of the basic body being sinuous so as to form a hinge, which collar comprises a plurality of flexible tabs inclined toward said hinge, distributed circumferentially and projecting radially inwardly, on a radially inward surface of the basic body on each side of the hinge.

2. The quick-action clamping collar as claimed in claim 1, wherein the basic body has on one side of the collar an area that is wider than the locking ends.

3. The quick-action clamping collar as claimed in claim 1, wherein the collar is configured for connecting flexible or semiflexible single-skin duct or double-skin duct with integrated insulating layer.

4. The quick action clamping collar as claimed in claim 1, wherein said single-skin or double-skin duct comprises an air conveying duct for a ventilation system.
